(19) United States
(12) Patent Application Publication
(10) Pub. No.: US 2009/0150144 A1
(43) Pub. Date: Jun. 11, 2009

(54) Robust voice detector for receive-side automatic gain control

(75) Inventors: Rajeev Nongpiur, Vancouver (CA); Kyle MacDonald, Vancouver (CA)

Correspondence Address: HARMAN - BRINKS HOFER CHICAGO;Brinks Hofer Gilson & Lione, P.O. Box 10395, Chicago, IL, 60610, US

(73) Assignee: QNX SOFTWARE SYSTEMS (WAVEMAKERS), INC., Vancouver (CA)

(21) Appl. No.: 11/953,629

(22) Filed: Dec. 10, 2007

(51) Int. Cl. G10L 15/00

(52) U.S. Cl. 704/233; 704/E15.039

(57) ABSTRACT

A voice detector improves voice output quality. The voice detector may be incorporated into a cellphone, hands-free car phone, or any other device that provides voice output. The voice detector provides excellent voice output quality even when signal dropouts and other significant signal artifacts are present in the received signal. Not only does the high quality voice output improve the listening experience, it also benefits downstream processing systems that further process the voice signal.

### BACKGROUND OF THE INVENTION

1. Technical Field

This disclosure relates to signal processing systems, and in particular, to a voice detector.

2. Related Art

Rapid developments in modern technology have led to the widespread adoption of cellphones, car phones, and an extensive variety of other devices that produce voice output. For these devices, the voice output quality is an important purchasing consideration for any consumer, and also has a significant impact on downstream processing systems, such as voice recognition systems. However, the device often faces severe technical challenges in producing excellent voice output. The technical challenges are amplified because of factors that the device cannot control.

In particular, voice output quality is affected by received signal strength, noise in the received signal, and environmental effects that corrupt, distort, or otherwise alter the transmitted signal. For example, cellular networks often introduce dropout and gating distortion in the receive-side signal. Such artifacts cause significant degradation in voice output quality. Furthermore, the voice output produced by prior devices was not robust in the face of widely varying signal-to-noise ratios.

Therefore, a need exists for a voice detector with improved performance despite the problems noted above and other previously encountered.

### SUMMARY

A voice detector that is robust to adverse signal conditions helps a system provide consistently good voice output quality. The voice detector may be incorporated into a cellphone, hands-free car phone, or any other device that provides voice output. The voice detector is robust despite signal dropouts and gating, widely varying signal-to-noise ratios, or other adverse signal conditions that affect a received signal.

The voice detector includes a noise estimate input, a frame characteristic input, and a signal-to-noise ratio (SNR) estimator. The SNR estimator is coupled to the noise estimate input and the frame characteristic input. The SNR estimator includes an SNR measurement output.

The voice detector also includes a smooth voice magnitude estimator connected to the SNR measurement output and the frame characteristic input. The smooth voice magnitude estimator includes a smooth voice signal output. The voice detector further includes voice decision logic connected to the smooth voice signal output and the frame characteristic input. The voice detector includes a voice detection output that provides a voice detection value that is robust to adverse signal conditions.

Other systems, methods, features and advantages will be, or will become, apparent to one with skill in the art upon examination of the following figures and detailed description. All such additional systems, methods, features and advantages are included within this description, are within the scope of the claimed subject matter, and are protected by the following claims.

### BRIEF DESCRIPTION OF THE DRAWINGS

The voice detector may be better understood with reference to the following drawings and description. The elements in the figures are not necessarily to scale, emphasis instead being placed upon illustrating the principles of the capability analysis techniques. In the figures, like-referenced numerals designate corresponding parts throughout the different views.

FIG. 1 shows a signal processing system including a voice detector.

FIG. 2 shows a voice detector.

FIG. 3 shows a signal processing system that implements a voice detector.

FIG. 4 shows an input signal.

FIG. 5 shows an input signal and a gain controlled input signal.

FIG. 6 shows a signal to background noise ratio (SBNR) signal.

FIG. 7 illustrates a voice detection value waveform based on a SBNR signal.

FIG. 8 shows an SBNR signal and a signal to smooth voice magnitude ratio (SSVMR) signal.

FIG. 9 shows a voice detection value waveform generated by voice decision logic.

FIG. 10 shows a comparison between voice detection value waveforms based on a SBNR signal and a SSVMR signal.

FIG. 11 shows a flow diagram of automatic gain control processing.

FIG. 12 shows a flow diagram of voice detector processing.

### DETAILED DESCRIPTION OF THE PREFERRED EMBODIMENTS

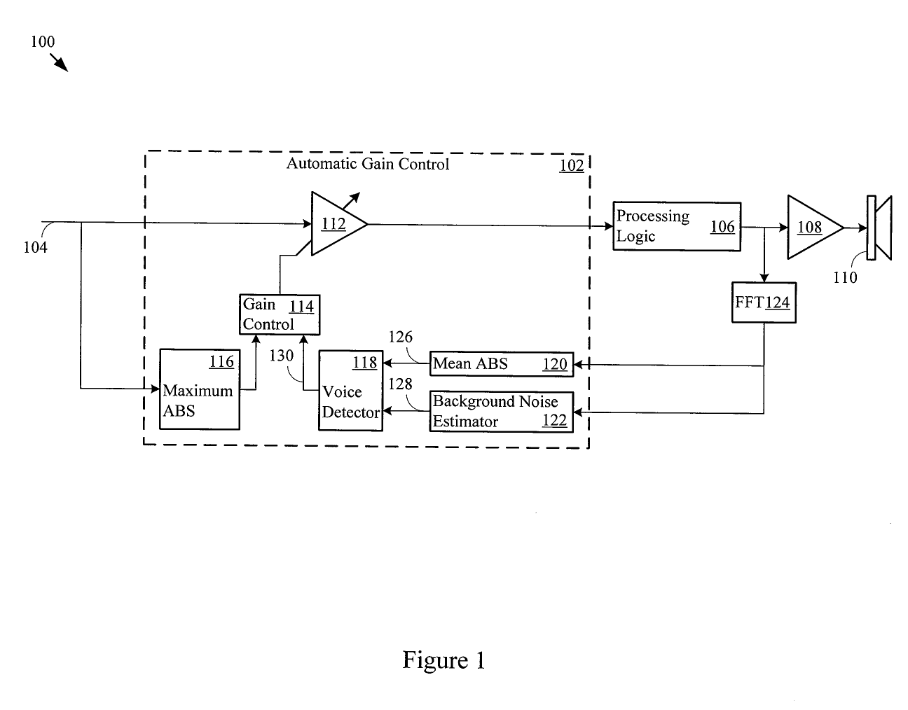

FIG. 1 shows a signal processing system 100. In the example shown in FIG. 1, the signal processing system 100 is a hands-free carphone system that includes automatic gain control logic 102. The automatic gain control logic 102 adjusts an input signal received on the signal input 104 for downstream processing logic 106. The output amplifier 108 amplifies the output of the downstream processing logic 106 to drive the speaker 110. The downstream processing logic 106 may take many forms, such as a bandwidth extender, noise reduction system, echo canceller, voice recognition system, or any other logic that processes signals, either for output via a speaker, or for any other purpose.

The automatic gain control logic 102 adjusts the input signal to stay above a lower magnitude bound and below an upper magnitude bound. To that end, the automatic gain control logic 102 uses a variable amplifier 112 driven by gain control logic 114. The gain control logic 114 responds to the maximum absolute value logic 116 and the voice detector 118 to determine when and by how much to amplify or attenuate the input signal to stay within the upper magnitude bound and the lower magnitude bound. For example, the gain control logic 114 may adjust the gain for the variable amplifier 112 on a per-frame basis, and voice, lack of voice, and signal artifacts may exist at one or more places in the frame.

The voice detector 118 accepts inputs from the mean absolute value logic 120 and the background noise estimator 122. In the implementation shown in FIG. 1, the fast Fourier transform (FFT) logic 124 provides a frequency domain representation of the gain controlled input signal to the mean absolute value logic 120 and the background noise estimator 122. The length of the FFT may be set to the frame size.

The mean absolute value logic 120 provides a mean absolute value to the voice detector 118 on the block characteristic input 126. The mean absolute value may be the sum of the amplitude values of the frequency domain representation generated by the FFT 124, divided by the number of frequency bins in the frequency domain representation.

The background noise estimator 122 provides a background noise estimate value to the voice detector 118 on the noise estimate input 128. The automatic gain control logic 102 may operate on frames of signal samples. For example, the mean absolute value may be the mean, denoted ∥x(n)∥, of the absolute values of the frequency magnitude components contained within a frequency domain signal sample frame. Similarly, the maximum absolute value provided by the maximum absolute value logic 116 may be the maximum absolute value of signal samples in time domain sample frame of the input signal. Depending on the mean absolute value and the background noise estimate value, the voice detector 118 produces a robust voice detection value on the voice detection output 130.

The frames may vary widely in length. As examples, the frames may be between 16 and 1024 samples in length (e.g., 512 samples), between 64 and 512 samples in length (e.g., 128 or 256 samples), or may be another length, generally a power of two. Furthermore, the signal processing system 100 may implement frame shift processing. For example, when the frame shift is 64 samples and the frame length is 128 samples, the signal processing system 100 forms a current frame by dropping the oldest 64 samples of the input signal and shifting in the newest 64 samples to form the current frame (rather than replacing an entire frame with 128 new samples). The signal processing system 100 uses the current frame for the purposes of determining the maximum absolute value, the mean absolute value, the background noise estimate, or other parameters. The frame shift may also vary in size, such as between 16 and 128 samples.

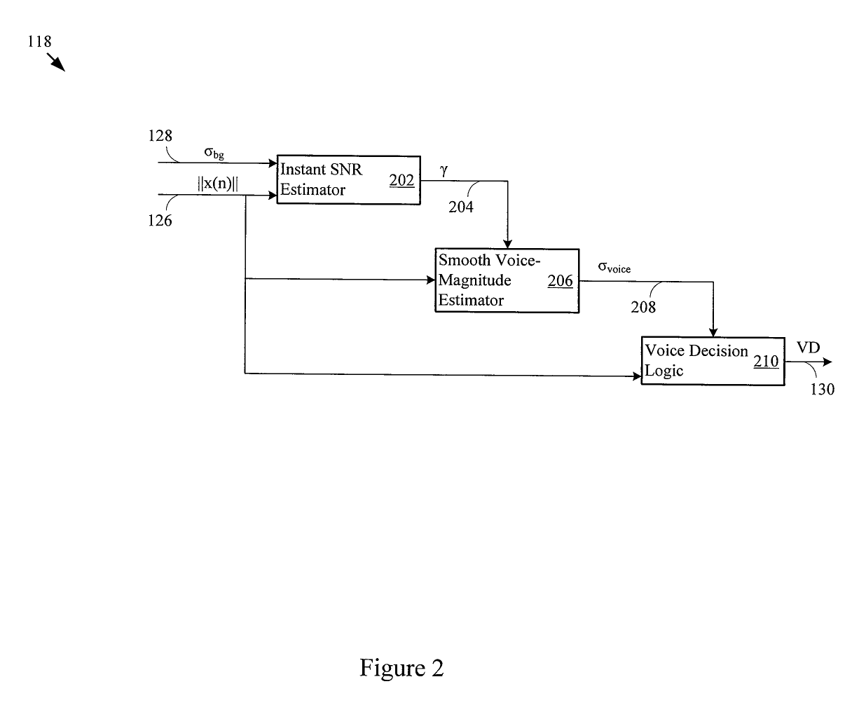

FIG. 2 shows the voice detector 118 in greater detail. The voice detector 118 includes a signal-to-noise ratio (SNR) estimator 202 with a SNR measurement output 204, a smooth voice magnitude estimator 206 with a smooth voice signal output 208, and voice decision logic 210. The voice decision logic 210 includes the voice detection output 130.

The SNR estimator 202 produces a SNR measurement value, γ, on the SNR measurement output 204. The SNR measurement value may be an ‘instant’ SNR value in the sense that it is determined for each new frame. For example:

$$γ = \frac{‖ x ( n ) ‖}{{σ}_{bg}}$$

where ∥x(n)∥ is the mean absolute value determined over the frequency domain frame received from the FFT 124, and σ_{bg} is the background noise estimate value. Other SNR formulations may be used with additional, fewer, or different parameters.

The smooth voice magnitude estimator 206 determines a smooth voice signal output value, σ_{voice}. For example:

$${σ}_{voice} ( n ) = \{ \begin{matrix}( 1 - α ) {σ}_{voice} ( n - 1 ) + α ‖ x ( n ) ‖ & if γ > Γ , \\ {σ}_{voice} ( n - 1 ) & otherwise .\end{matrix}$$

where σ_{voice}(n) represents the smooth voice signal output value, γ represents the SNR measurement value, and Γ represents a SNR threshold. To that end, the smooth voice magnitude estimator 206 may include generator decision logic (e.g., conditional statement evaluations) that selects between multiple smooth voice signal generators based on the SNR measurement value. In the example shown above, the first smooth voice signal generator is:

(1−α)σ_{voice}(n−1)+α∥x(n)∥

while the second smooth voice signal generator is:

σ_{voice}(n−1)

Thus, when the SNR measurement value is great enough, the smooth voice magnitude estimator 206 generates a current smooth voice signal output based on the prior smooth voice signal output and ∥x(n)∥. If the SNR measurement value is too low, however, the smooth voice magnitude estimator 206 uses the prior smooth voice signal output as the current smooth voice signal output. As a result, the smooth voice magnitude estimator 206 controls how strongly to modify the smooth voice signal output, given the SNR measurement value for the current frame, and may make no change at all.

The smooth voice magnitude estimator 206 may further implement multiple different adaptation rates, α. For example, the smooth voice magnitude estimator 206 may include adaptation rate decision logic that selects between a fast adaptation rate, α_{fast}, and a slow adaptation rate, α_{slow}. As one example:

$$α = \{ \begin{matrix}{α}_{fast} & if ‖ x ( n ) ‖ > {σ}_{voice} ( n - 1 ) , \\ {α}_{slow} & otherwise .\end{matrix}$$

where α represents the current adaptation rate value, α_{fast} represents the first adaptation rate value, α_{slow} represents the second adaptation rate value, ∥x(n)∥ represents the frame characteristic value (e.g., the mean absolute value), and σ_{voice}(n−1) represents the immediately prior smooth voice signal output value.

Accordingly, when the current frame includes significant energy (e.g., energy above the prior smooth voice signal output value), the adaptation rate selection logic chooses a fast adaptation rate value. Significant energy above the prior smooth voice signal output value tends to indicate that voice is still present in the frame. When significant energy is not present, the adaptation rate selection logic chooses a slower adaptation rate value. Then, depending on the SNR measurement value, the smooth voice magnitude estimator 206 may adapt quickly, slowly, or not at all.

In other implementations, the voice detector 118 may include additional, fewer, or different smooth voice signal generators or adaptation rate values. For example, other implementations may select between three adaptation rate values or three smooth voice signal generators depending on signal conditions, the type of signal processing system 100, or other variables. Furthermore, the voice detector 118 may dynamically change the number of smooth voice signal generator or adaptation rate values depending on prevailing or expected signal conditions.

The voice decision logic 210 analyzes the current smooth voice signal output value and the frame characteristic value. Based on the analysis, the voice decision logic 210 provides a voice detection value (“VD”) on the voice detection output 130. VD may be a logic ‘1’ to indicate that voice is present, and logic ‘0’ to indicate that voice is absent in the current frame. The voice decision logic 210 may implement:

$$VD = \{ \begin{matrix}1 & if ‖ x ( n ) ‖ > k {σ}_{voice} , \\ 0 & otherwise .\end{matrix}$$

where VD represents the voice detection value, and k represents a voice detector tuning parameter.

The voice decision logic 210 determines that voice is present in the current signal frame when the frame characteristic (e.g., the mean absolute value) exceeds a voice presence threshold (shown in the example above as kσ_{voice}). In other words, when the energy in the current frame exceeds a certain fraction of the energy attributed to the current voice estimate, the voice decision logic 210 concludes that voice is present. The final decision does not depend directly on the SNR, but the SNR is considered when determining σ_{voice}. One benefit is that the voice detector 118 becomes robust against the effects of widely varying SNR, and the SNR based detrimental effects of signal gating and dropout.

The voice detector tuning parameter may be adjusted upwards to require a stronger presence of the frame characteristic. Similarly, the voice detector tuning parameter may be adjusted lower to require a weaker presence of the frame characteristic. The voice presence threshold may be expressed in terms of the current smooth voice signal output value or may take other forms that include additional, fewer, or different parameters.

Table 1, below, shows example approximate parameter values for the voice detector 118 in a hands-free carphone system. The parameter values for any particular implementation may be changed to adapt the implementation in question to any expected or predicted signal conditions or signal characteristics and for any particular system implementation. For example, the sampling rate may be 16, 18, 22, or 44 kHz and may be selected to accurately capture the bandwidth of the input signal.

TABLE 1

| Parameter | Example Value |
|---|---|
| Γ | 2 |
| α_{fast} | 0.01 |
| α_{slow} | 0.001 |
| k | 0.3 |
| frame size | 256 samples |
| frame shift | 64 samples |
| sampling rate | 11.025 kHz |
| FFT length | frame size |

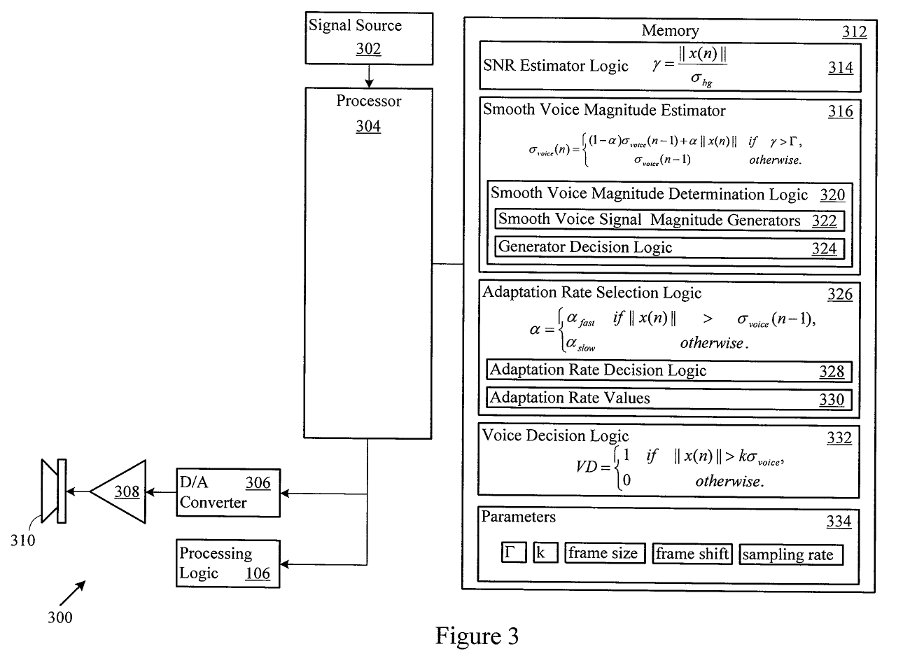

FIG. 3 shows a signal processing system 300 that implements the voice detector 118. A signal source 302 delivers an input signal to the processor 304. The signal source 302 may include a microphone or microphone array. The signal source 302 may also be a communication interface that receives digital signal samples or an analog input signal from another source. After processing, the processor 304 provides processed digital signal samples to the digital-to-analog converter 306 or the processing logic 106. The digital-to-analog converter may feed the amplifier 308 that in turn drives the output transducer 310 (e.g., a speaker).

The memory 312 stores voice detector parameters and logic executed by the processor 304. The logic includes SNR estimator logic 314. The SNR estimator logic 312 may include instructions that determine the SNR measurement value, γ. Also included in the memory 312 is the smooth voice magnitude estimator 316, which uses the smooth voice magnitude determination logic 320 to determine a smooth voice signal output value, σ_{voice}. To that end, the smooth voice magnitude determination logic 320 may include one or more smooth voice signal magnitude generators 322 and generator decision logic 324. The generator decision logic 324 selects between the smooth voice signal magnitude generators 322. For example, the generator decision logic 324 may determine which smooth voice signal magnitude generator to apply depending on whether the SNR measurement value exceeds a threshold.

The adaptation rate selection logic 326 provides α, the current adaptation rate value to the smooth voice magnitude estimator 316. In that regard, the adaptation rate decision logic 328 may select between multiple adaptation rate values 330, such as α_{fast} and α_{slow}. The decision may be made based on ∥x(n)∥, the frame characteristic value (e.g., the mean absolute value of the signal components in the frequency domain frame) in comparison with σ_{voice}(n−1), the immediately prior smooth voice signal output value. Other tests, comparisons, or other decision logic may be employed to determine which adaptation rate to select as the current adaptation rate value. For example, values of σ_{voice} other than the immediately prior version may be used in the comparison.

The memory 312 also includes the voice decision logic 332. The voice decision logic 332 provides a voice detection value, VD. As one example, VD switches between a logic ‘1’ to indicate the presence of voice based on the frame characteristic value (e.g., ∥x(n)∥) in comparison to a threshold (e.g., kσ_{voice}), and a logic ‘0’ to indicate the absence of voice. Subsequent processing logic, such as the gain control logic 114 may employ the voice detection value in the process or determining how to adjust the gain of the variable gain amplifier 112. However, any other processing logic may receive the voice detection value for processing. Furthermore, any of the signal processing system 100 may be implemented in the signal processing system 300 as well, such as the background noise estimator 122, mean absolute value logic 120, maximum absolute value logic 116, FFT 124, and gain control logic 114.

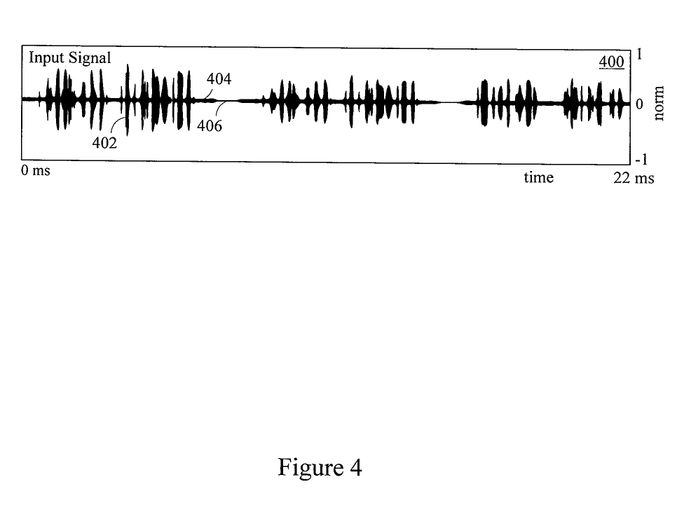

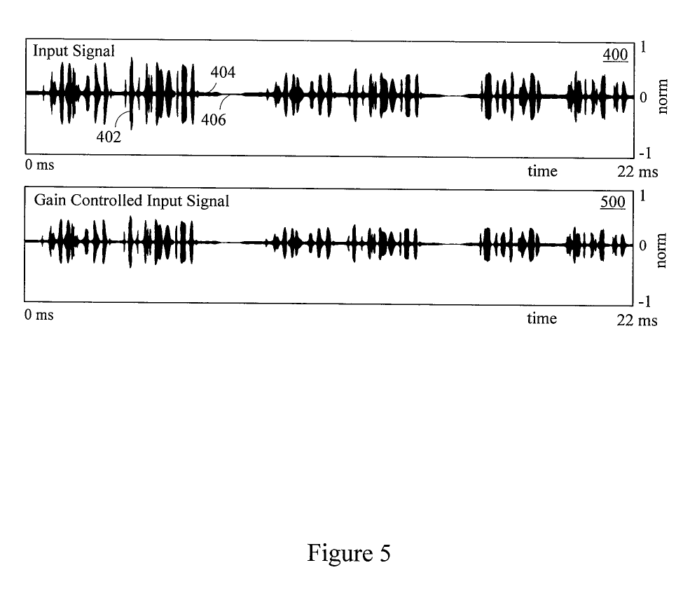

FIG. 4 shows an example of an input signal 400. The input signal 400 extends over a time axis of approximately 0 to 22 ms, and a normalized value axis of −1 to 1. FIG. 4 labels an example of voice 402, an example of the absence of voice 404, and a signal dropout 406 in the input signal. Voice and signal artifacts (such as gating or dropout) may be present or absent at any place in the input signal. The signal dropout 406 causes the input signal level to drop to almost zero. FIG. 5 shows an example of the input signal 400 after gain control to obtain the gain controlled input signal 500. In the example in FIG. 5, the gain controlled input signal 500 is an attenuated version of the input signal 400 so that the gain controlled input signal 500 remains above a lower magnitude bound and below an upper magnitude bound.

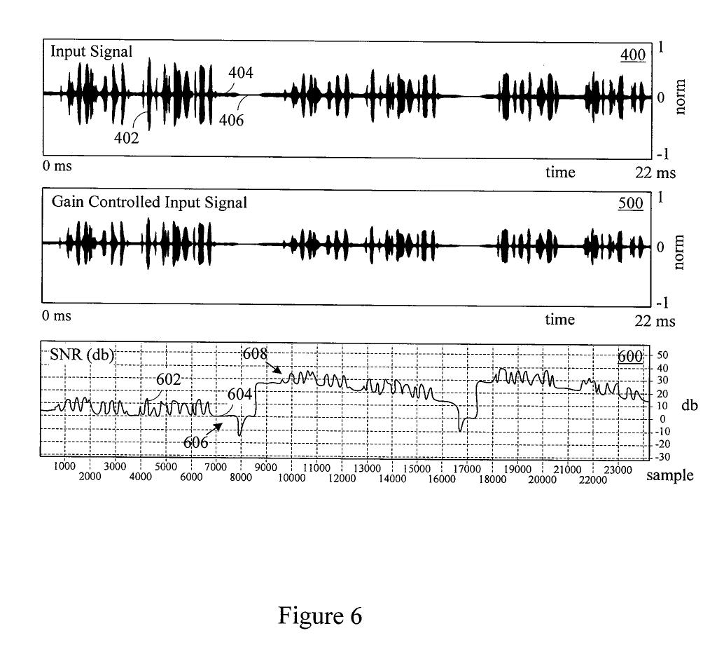

FIG. 6 shows a SNR signal 600. More specifically, the SNR signal 600 is a signal to background noise ratio (SBNR) signal determined by the background noise estimator 122. The SBNR signal increases as the signal 500 increases over the background noise, such as during the voice 402, as shown by the increased SBNR 602. The SBNR signal decreases in the absence of voice, as shown by the decreased SBNR 604. The signal dropout 406 induces the SNR artifact 606 in the SNR signal 600. The SNR artifact 606 conveys an inaccurate estimation of the true SNR and also detrimentally influences the SNR determinations for significant subsequent time periods, such as at time period 608, where the SNR is artificially high. Nevertheless, the voice detector 118 is robust to such artifacts.

Just prior to the signal dropout 406, the low, but still present, input signal level translates to a very low SNR. When the signal dropout 406 occurs, the SNR quickly spikes downward due to the almost complete absence of signal. However, the background noise estimate adapts during the signal dropout 406 to at or near zero and the SNR gradually recovers. However, when any amount of signal returns after the signal dropout 406, the SNR spikes and remains artificially high (e.g., at period 608) while the SNR adapts again toward an accurate SNR estimate.

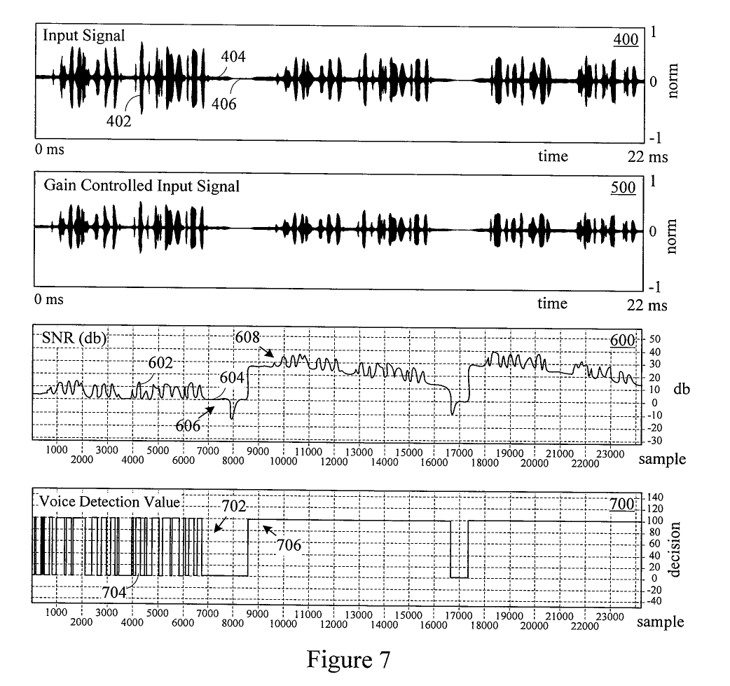

FIG. 7 shows a voice detection value waveform 700 resulting from making a voice detection decision based on the SNR signal 600 against a threshold. Prior to the signal dropout 406, in the region denoted 702, the voice detection decision accurately tracks the presence or absence of voice in the input signal 500. For example, the voice 402 corresponding to the increased SBNR 602 results in a voice detection 704. However, after the signal dropout 406, in the region 706, the artificially increased SNR causes almost constant voice detection. As a result, the automatic gain control attempts to greatly amplify a very low level input signal to keep it above the lower magnitude bound. Then, when voice actually returns in the input signal, increasing the input signal level, the voice is amplified beyond clipping by the amplifier, resulting in distorted voice output. The voice detector 118 is robust against such effects.

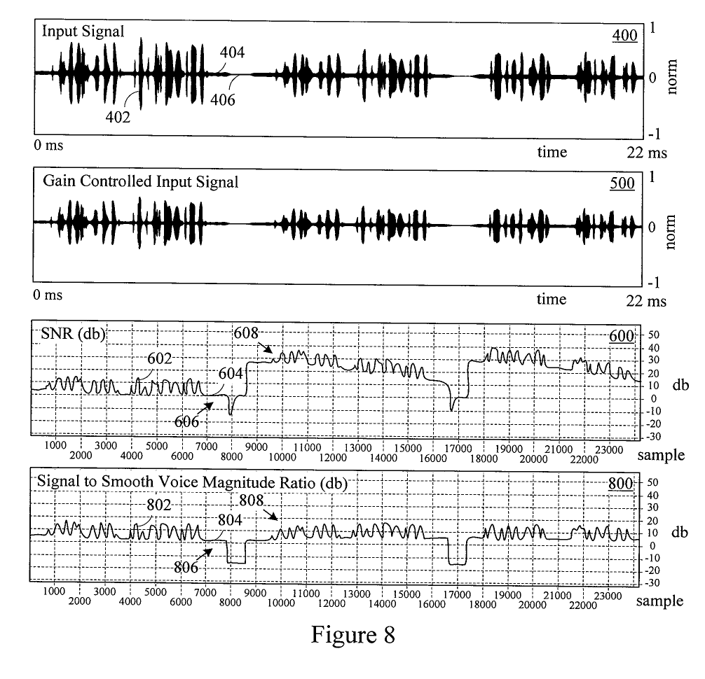

FIG. 8 shows a signal-to-smooth voice magnitude ratio (SSVMR) signal 800. The SSVMR 800 represents the ratio of the gain controlled input signal 500 to the smooth voice signal output value, σ_{voice}. The smooth voice magnitude estimator 206 generates the smooth voice signal output value in a controlled manner. In particular, the smooth voice signal output value changes on a sample-by-sample basis according to a variable adaptation rate set for a frame of samples and according to a selected smooth voice signal generator. One result is that signal dropouts do not cause the SSVMR to spike or reach artificially high levels. In FIG. 8, the SSMVR peak 802 accurately reflects presence of the voice 402. When the voice is absent, the SSMVR declines, as shown by the SSMVR 804.

The SSMVR section 806 shows the effect of the signal dropout 406. The SSMVR drops but recovers. The SSMVR section 808 shows that the SSMVR signal does not spike or reach artificially high levels. Instead, the SSMVR continues to provide an accurate representation of peaks attributable to voice in the input signal 500. In part, the accurate representation is aided by having the adaptation rate selection logic constrain changes to the smooth voice signal output value. When the frame characteristic does not exceed a prior smooth voice signal output value (e.g., during signal gating or dropout), the current smooth voice signal output value adapts slowly, and does not adapt at all unless the SNR value determined by the SNR estimator 202 is sufficiently high.

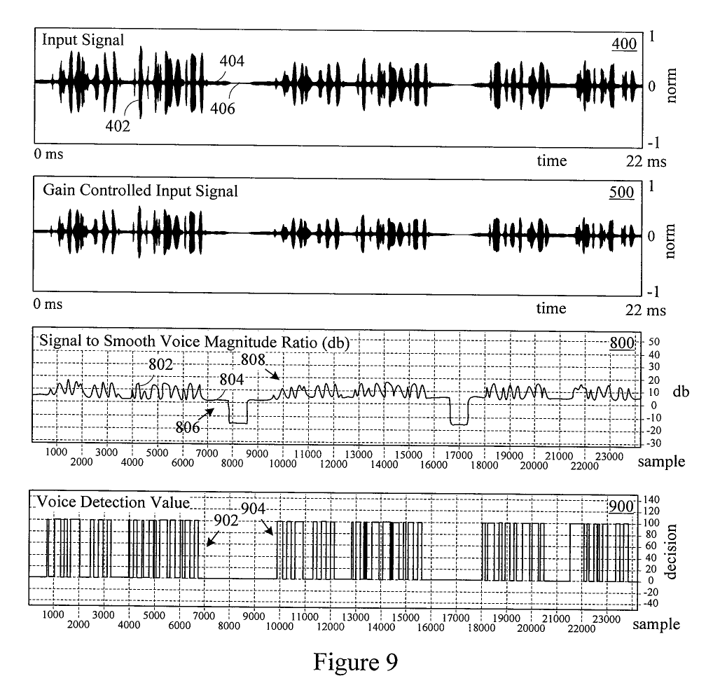

FIG. 9 shows a voice detection value waveform 900 generated by the voice decision logic 210. The voice decision logic 210 makes the voice presence determination based on the smooth voice signal output value, σ_{voice}. In the waveform region 902, the voice detection value accurately tracks the presence of voice in the input signal 500. However, the voice detection value is robust against the signal dropout 406 as shown in the waveform region 904. The smooth voice signal output value does not rise to artificially high levels despite the signal dropout 406, but does continue to accurately reflect the presence of voice in the input signal 500. As a result, voice decisions made by the voice decision logic 210 continue to accurately track the presence of voice in the input signal 500, in a manner robust to signal gating and dropout. One benefit is that the automatic gain control does not attempt to overamplify a very low level input signal to keep it above the lower magnitude bound. Accordingly, when voice actually returns in the input signal after the dropout and increases the input signal level, the voice level stays within the upper and lower amplifier bounds and is not clipped. Consistently good speech output quality results.

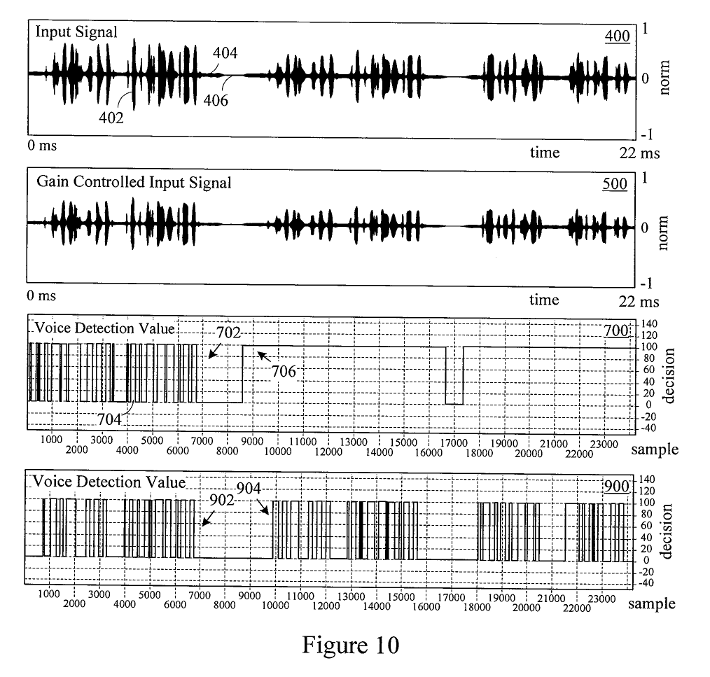

FIG. 10 shows a comparison between voice detection value waveforms 700 and 900 based on a SBNR signal 600 and a SSVMR signal 800. The voice detection value waveform 900 produced by the voice detector 118 accurately tracks the voice content in the input signal 500 despite the presence of multiple signal dropouts. On the other hand, the voice detection value waveform 700 falsely detects voice for extensive portions of the input signal because of the signal dropouts.

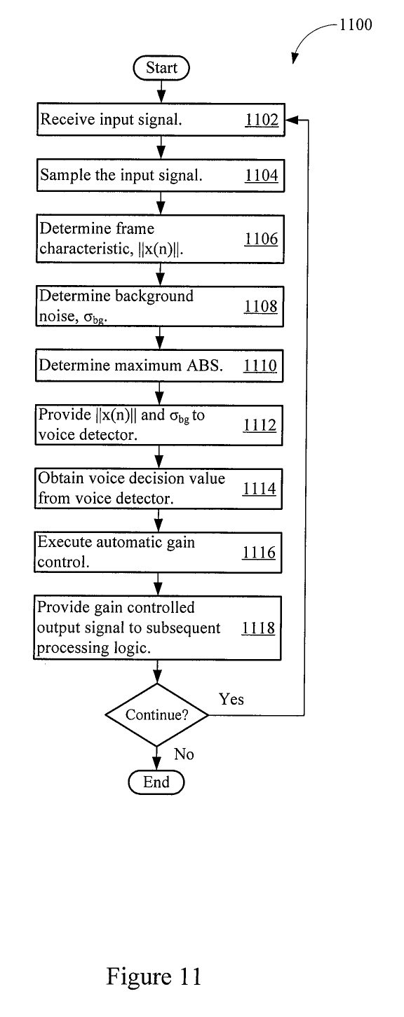

FIG. 11 shows an example of the processing logic 1100 that implements automatic gain control. The automatic gain control system 102 receives an input signal (1102). The input signal may be a signal received by a hands-free carphone, received over a digital communication interface, read from memory, or received in another manner. The automatic gain control system 102 samples the input signal (1104) (e.g., to obtain frames of signal samples). The automatic gain control system 102 also determines several parameters, including a frame characteristic value (e.g., ∥x(n)∥) (1106), a background noise σ_{bg} (1108), and a maximum absolute value in the signal frame (1110).

The parameters ∥x(n)∥ and σ_{bg} are provided to the voice detector 118 (1112). The voice detector 118 determines whether voice is present. The automatic gain control system 102 obtains the voice decision values from the voice detector 118 (1114). With the voice decision values and the maximum absolute value, the automatic gain control system 102 adjusts the variable gain amplifier 112 to execute automatic gain control (116). The automatic gain control system 102 may provide the gain controlled output signal to subsequent processing logic (1118).

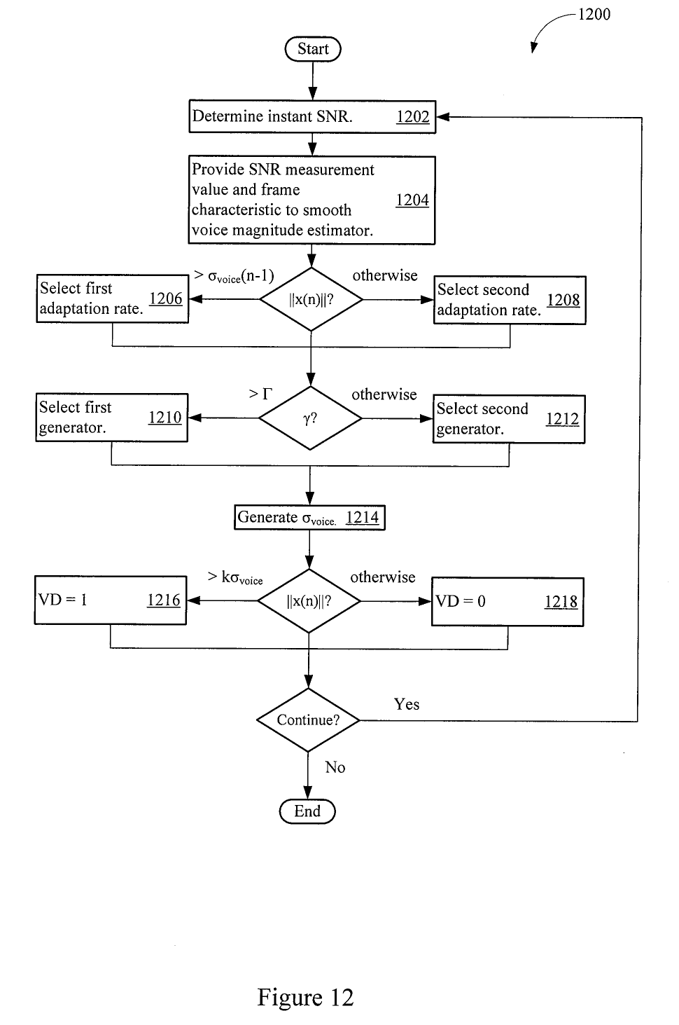

FIG. 12 shows a flow diagram of voice detector processing 1200 by the voice detector 118 or voice detection logic in the memory 312. The SNR estimator logic 314 determines a localized SNR, γ, such as an ‘instant’ SNR (1202). The localized SNR may be determined on a frame-by-frame or other basis. The SNR estimator logic 314 provides the localized SNR to the smooth voice magnitude estimator 316 (1204).

The adaptation rate selection logic 326 executes an adaptation test to determine which adaptation rate to select. For example, the frame characteristic value, ∥x(n)∥, may drive a decision between a first adaptation rate (1206) and a second adaptation rate (1208). The smooth voice magnitude determination logic 320 executes a generator test to select between smooth voice magnitude signal generators 322. For example, the localized SNR may drive a decision between the first signal generator (1210) and the second signal generator (1212). Given the selected adaptation rate and signal generator, the smooth voice magnitude estimator 316 generates the current smooth voice magnitude value σ_{voice} (1214).

The voice decision logic 332 may employ the current smooth voice magnitude value σ_{voice} to determine whether voice is present at any particular point in the input signal. To that end, the voice decision logic 332 may execute a voice detection test. For example, if the frame characteristic value is sufficiently large (e.g., greater than kσ_{voice}), then the voice decision logic may set VD=‘1’ to indicate the presence of voice (1216), and otherwise set VD=‘0’ to indicate the absence of voice (1218).

The voice detector may be implemented in many different ways. For example, although some features are shown stored in machine-readable memories (e.g., as logic implemented as computer-executable instructions in memory or as data structures in memory), all or part of the system, its logic, and data structures may be stored on, distributed across, or read from other machine-readable media. The media may include machine or computer storage devices such as hard disks, floppy disks, or CD-ROMs; a signal, such as a signal received from a network or received over multiple packets communicated across the network; or in other ways. The voice detector may be implemented in software, hardware, or a combination of software and hardware.

Furthermore, the voice detector may be implemented with additional, different, or fewer components. As one example, a processor in the voice detector may be implemented as with microprocessor, a microcontroller, a Digital Signal Processor (DSP), an application specific integrated circuit (ASIC), discrete analog or digital logic, or a combination of other types of circuits or logic. As another example, memories may be DRAM, SRAM, Flash or any other type of memory. The voice detector may be distributed among multiple components, such as among multiple processors and memories, optionally including multiple distributed processing systems. Logic, such as programs or circuitry, may be combined or split among multiple programs, distributed across several memories, processors, or other circuitry. The logic may be implemented in a function library, such as a shared library (e.g., a dynamic link library (DLL)) defining voice detection function calls that implement the voice detector logic. Other systems or applications may call the functions to provide voice detection features.

The voice detector 118 may be a part of any device that processes voice. As one example, the signal processing system 100 may be a car phone system, such as a hands-free carphone system. As other examples, the signal processing system 100 may be included in a cellphone, video game, personal data assistant, personal communicator, or any other device.

The voice detector 118 uses the smooth voice signal output value to obtain the voice detection value. Instead of using the background noise estimate value to threshold the input signal for voice detection, the voice detector 118 uses an alternate technique that provides robustness to dropouts, gating, and other adverse signal characteristics. The voice detector 118 provides unexpectedly good performance, particularly in view of the use in the voice detector of the background noise estimate value, which, as noted above, contributed to poor performance in past systems in the presence of adverse influences on the input signal, including signal gating and dropout.

The signal processing system 100 may activate the voice detector 118, adapt its parameters, or deactivate the voice detector 118 depending on prevailing or expected signal conditions, timing schedules, device activations, or other decision factors. As one example, during rush hour traffic when heavy call volumes trigger an increase in signal gating, the signal processing system 100 may activate the voice detector 118 to provide enhance voice output quality. As another example, the signal processing system 100 may activate the voice detector 118 when the hands-free carphone is in use.

The voice detector 118 decouples voice detection decisions from direct reliance on SNR. Instead, the voice detector 118 uses σ_{voice} as a basis for making a voice detection decision. The σ_{voice} parameter is very robust to drop out, gating, and widely varying signal-to-noise ratios because σ_{voice} typically remains steady over time in part because voice tends to remain at about the same level over time. A drop out or gating event instead significantly changes the background noise estimate rather than σ_{voice}. Using σ_{voice} as a reference point helps the voice detector 118 remain robust in the face of significant input signal artifacts.

While various embodiments of the voice detector have been described, it will be apparent to those of ordinary skill in the art that many more embodiments and implementations are possible within the scope of the invention. Accordingly, the invention is not to be restricted except in light of the attached claims and their equivalents.

What is claimed is:

1. A voice detector comprising:
a noise estimate input;
a frame characteristic input;
a signal-to-noise ratio (SNR) estimator coupled to the noise estimate input and the frame characteristic input and comprising an SNR measurement output;
a smooth voice magnitude estimator coupled to the SNR measurement output and the frame characteristic input and comprising a smooth voice signal output;
voice decision logic coupled to the smooth voice signal output and the frame characteristic input and comprising a voice detection output.

2. The voice detector of claim 1, where the frame characteristic input comprises:
a mean absolute value input operable to provide a mean absolute value of a signal sample frame to the SNR estimator.

3. The voice detector of claim 2, where the signal sample frame comprises:
frequency domain signal samples, time domain signal samples, or a combination of both frequency domain signal samples and time domain signal samples.

4. The voice detector of claim 1, where:
the noise estimate input comprises a background noise estimate input operable to provide a background noise estimate value to the SNR estimator.

5. The voice detector of claim 1, where:
the smooth voice magnitude estimator comprises:
adaptation rate selection logic operable to select a current adaptation rate value from multiple available adaptation rate values; and
smooth voice magnitude determination logic operable to generate a current smooth voice signal magnitude taking into consideration the current adaptation rate value.

6. The voice detector of claim 1, where:
the SNR measurement output is operable to provide an SNR measurement value to the smooth voice magnitude estimator; and
the smooth voice magnitude determination logic comprises:
a first smooth voice signal magnitude generator;
a second smooth voice signal magnitude generator; and
generator decision logic operable to select between the first and second smooth voice signal magnitude generators based on the SNR measurement value.

7. The voice detector of claim 5, where:
the frame characteristic input is operable to provide a frame characteristic value to the smooth voice magnitude estimator; and where:
the multiple adaptation rate values comprise:
a first adaptation rate value;
a second adaptation rate value; and where:
the adaptation rate selection logic comprises:
adaptation rate decision logic operable to select between the first adaptation rate value and the second adaptation rate value as the current adaptation rate value based on the frame characteristic value.

8. The voice detector of claim 7, where the adaptation rate decision logic implements:
$$α = \{ \begin{matrix}{α}_{fast} & if ‖ x ( n ) ‖ > {σ}_{voice} ( n - 1 ) , \\ {α}_{slow} & otherwise .\end{matrix}$$
where α comprises the current adaptation rate value, α_{fast} comprises the first adaptation rate value, α_{slow} comprises the second adaptation rate value, ∥x(n)∥ comprises the frame characteristic value, and σ_{voice}(n−1) comprises a prior smooth voice signal magnitude.

9. A product comprising:
a machine readable medium;
signal-to-noise ratio (SNR) estimator logic stored on the medium and operable to accept a noise estimate value and a frame characteristic value and generate a SNR measurement value;
smooth voice magnitude estimator logic stored on the medium and operable to accept the SNR measurement value and the frame characteristic value and generate a smooth voice signal output value;
voice decision logic stored on the medium and operable to accept the smooth voice signal output value and the frame characteristic value and generate a voice detection value.

10. The product of claim 9, where the noise estimate value comprises:
a background noise estimate value.

11. The product of claim 9, where the frame characteristic value comprises:
a mean absolute value of a signal sample frame.

12. The product of claim 9, where:
the smooth voice magnitude estimator logic comprises:
adaptation rate selection logic operable to select a current adaptation rate value from multiple available adaptation rate values; and
smooth voice magnitude determination logic operable to generate a current smooth voice signal magnitude using the current adaptation rate value.

13. The product of claim 12, where:
the multiple adaptation rate values comprise:
a first adaptation rate value;
a second adaptation rate value; and where:
the adaptation rate selection logic comprises:
adaptation rate decision logic operable to select between the first adaptation rate value and the second adaptation rate value as the current adaptation rate value based on the frame characteristic value.

14. The product of claim 9, where:
the smooth voice magnitude determination logic comprises:
a first smooth voice signal magnitude generator;
a second smooth voice signal magnitude generator; and
generator decision logic operable to select between the first and second smooth voice signal magnitude generators based on the SNR measurement value.

15. The product of claim 9, where the smooth voice magnitude estimator logic implements:
$$α = \{ \begin{matrix}{α}_{fast} & if ‖ x ( n ) ‖ > {σ}_{voice} ( n - 1 ) , \\ {α}_{slow} & otherwise .\end{matrix}$$
where α comprises a current adaptation rate value, α_{fast} comprises a first adaptation rate value, α_{slow} comprises a second adaptation rate value, ∥x(n)∥ comprises the frame characteristic value, and σ_{voice}(n−1) comprises a prior smooth voice signal magnitude.

16. The product of claim 15, where the smooth voice magnitude estimator logic implements:
$${σ}_{voice} ( n ) = \{ \begin{matrix}( 1 - α ) {σ}_{voice} ( n - 1 ) + α ‖ x ( n ) ‖ & if γ > Γ , \\ {σ}_{voice} ( n - 1 ) & otherwise .\end{matrix}$$
where σ_{voice}(n) comprises the smooth voice signal output value, γ comprises the SNR measurement value, and Γ comprises a SNR threshold.

17. The product of claim 16, where the voice decision logic implements:
$$VD = \{ \begin{matrix}1 & if ‖ x ( n ) ‖ > k {σ}_{voice} , \\ 0 & otherwise .\end{matrix}$$
where VD comprises the voice detection value, and k comprises a voice detector tuning parameter.

18. A smooth voice magnitude estimator comprising:
adaptation rate selection logic operable to select a current adaptation rate value from among multiple available adaptation rate values; and
smooth voice magnitude determination logic operable to generate a current smooth voice signal magnitude using the current adaptation rate value.

19. The smooth voice magnitude estimator of claim 18, where:
the multiple available adaptation rate values comprise:
a first adaptation rate value; and
a second adaptation rate value approximately 5 to approximately 10 times greater than the first adaptation rate value.

20. The smooth voice magnitude estimator of claim 18, where:
the adaptation rate selection logic comprises:
adaptation rate decision logic operable to select among the multiple available adaptation rate values based on a signal sample frame characteristic value and a prior smooth voice magnitude value.

21. The smooth voice magnitude estimator of claim 20, where:
the signal sample frame characteristic value comprises a mean absolute value of a signal sample frame.

22. The smooth voice magnitude estimator of claim 20, where:
the signal sample frame characteristic value comprises a mean absolute value of: frequency domain signal samples, time domain signal samples, or a combination of both frequency domain signal samples and time domain signal samples.

23. The smooth voice magnitude estimator of claim 18, where:
the smooth voice magnitude determination logic comprises:
a first smooth voice signal magnitude generator;
a second smooth voice signal magnitude generator; and
generator decision logic operable to select between the first and second smooth voice signal magnitude generators.

24. The smooth voice magnitude estimator of claim 23, where:
the generator decision logic is operable to select the first smooth voice signal magnitude generator when a signal-to-noise ratio (SNR) value exceeds a SNR threshold.

25. The smooth voice magnitude estimator of claim 24, where:
the SNR value comprises a SNR value for a signal sample frame generated from a background noise estimate value and a mean absolute value of the signal sample frame.
